(19) United States
(12) Patent Application Publication
(10) Pub. No.: US 2014/0013924 A1
(43) Pub. Date: Jan. 16, 2014

(54) CAPO

(71) Applicant: C7TH LIMITED, Peterborough (GB)

(72) Inventor: Nicholas John Campling, Peterborough (GB)

(21) Appl. No.: 13/940,537

(22) Filed: Jul. 12, 2013

(30) Foreign Application Priority Data
Jul. 16, 2012 (GB) 1212614.0

(51) Int. Cl. G10D 3/04

(52) U.S. Cl. CPC G10D 3/043
USPC 84/318

(57) ABSTRACT

A capo, which can be manufactured at relatively low cost, comprised a top arm configured to extend across the strings of a musical instrument, with a side arm extending, in use, laterally of the instrument neck. A lower arm having one end pivotally attached to the side arm at a pivot point provides an adjustable clamping function by virtue of an adjuster mechanism. A resilient material is provided on a string facing side of the top arm that extends from the top arm onto the side arm, toward the location of the pivot point. The material includes an enlarged portion that provides a biasing force against an end of the lower arm away from the back of the neck, such that an additional metal spring or the like is not necessary.

### CROSS-REFERENCE TO RELATED APPLICATIONS

This application claims foreign priority benefits under 35 U.S.C. §119(a)-(d) to GB 1212614.0, filed Jul. 16, 2012, which is incorporated by reference in its entirety.

### TECHNICAL FIELD

The present disclosure relates to a capo for a stringed musical instrument, in particular to a low cost capo.

### BACKGROUND

A capo (sometimes referred to as a capodastro, capodaster, capotasto or cejilla) is a well-known device used with a stringed instrument, for example a guitar or banjo, which has a neck and a set of strings extending along the length of the neck. The capo, when applied to an instrument, serves to clamp the strings against the finger board of the neck and, in particular, between or against one of the numbers of fret bars disposed along the length of the finger board. In practice a capo serves to reduce the effective length of the strings and therefore adjust the pitch.

A large number of different capo types are known, each of which has a different advantage and technical consideration. Players often have a preference for a particular capo type based on its ease of use, effectiveness and cost/availability. Some capo types (e.g., with lever arms and/or clutch mechanisms) become complicated and expensive to manufacture and, hence, there is always a market need for low cost but effective mechanisms integrated into a capo.

### SUMMARY

According to a broad aspect of the present disclosure, there is provided a capo as described in the accompanying claims.

Particularly, the capo is for use with a stringed instrument having a neck with a finger board and a back and strings that extend longitudinally over said finger board, the capo being primarily constructed with: a top arm configured to, in use, extend across the finger board over the strings; a side arm connected and extending at an angle to the top arm and arranged to extend laterally of the neck; a lower arm having one end pivotally attached to the side arm at a pivot point and configured to, in use, abut against the back of the neck of the instrument when in a closed position; and an adjuster mechanism that extends and projects an adjustable amount from the side arm and having an end portion that bears against the lower arm such that it is able to cause the lower arm to move toward the back of the neck to the closed position. Also, movement of the end portion of the adjust mechanism away from the neck causes it to release its clamping action so the capo can be removed.

The disclosure is particularly characterized by the use of a resilient material provided on a string contacting side of the top arm that extends around the angle of the top arm connected to the side arm toward the location of the pivot point. The resilient material may incorporate an integral step, enlarged portion or protrusion that extends from the side arm toward a surface of the lower arm at a location that overhangs the pivot point with the side arm. In this way, the resilient material (e.g., of rubber) performs a spring bias function that urges the lower arm toward an open position. Accordingly, no separate spring (e.g., of resilient metal) is required to act on the lower arm.

The low cost capo of the invention also preferably utilizes a pressing manufacturing operation to produce the top/side arm and lower arm components. This results in components that have a generally U-shaped cross section with walls that form a channel. A rubber moulding is then applied to each pressed metal piece to provide the required soft surface against which the strings and neck of the instrument are contacted.

### DESCRIPTION OF THE DRAWINGS

FIG. 1 illustrates a cross-section view of a low cost capo according to the disclosure shown in the open position;

FIG. 2 illustrates a cross-section view of the capo in a closed position;

FIG. 3 illustrates a general side elevation view of the capo in an open position; and

FIG. 4 illustrates a side elevation view of the capo in a closed position.

### DETAILED DESCRIPTION

According to a preferred embodiment of the disclosure, the capo illustrated in the figures is comprised of a top string engaging arm 12 that in use is arranged to extend across the neck of an instrument (not illustrated), over and abutting against the strings of the instrument to, when closed, clamp the strings against the neck. The top arm 12 preferably includes a resilient rubber or similar pad 13 on its underside string engaging surface to cushion its engagement with the strings. A side arm 16 is configured to extend, in use, laterally of the instrument neck and from one end of the top arm 12. In this case side arm 16 is integrally formed with top arm 12.

A lower arm 18 is pivotally connected to side arm 16 by a pivot axis 20 located part-way along the side arm 16 between its distal end and the end which is connected with the top arm 12. In practice the pivot axis 20 would be comprised of a pin or rivet extending through both arm components and suitably secured to hold the capo together.

Lower arm 18 is configured such that in use it extends behind the back of the neck (not illustrated) and is often curved to generally fit the curve of the back of the instrument neck. A topside of lower arm 18 preferably supports a resilient pad or cushion surface 22 for engagement with the back of the neck.

An adjuster mechanism 24 is preferably located toward the distal end of side arm 16. It will be apparent that the pivot axis 20 for the lower arm is located between this adjuster mechanism 24 and the end of the side arm 16 connected with top arm 12. In the preferred embodiment adjuster mechanism 24 is a screw threaded shaft 25 received by a boss 26 with a corresponding internal screw thread. Boss 26 is affixed to the distal end of side arm 16 in a permanent arrangement (e.g., by welding, glue, etc). Threaded shaft 25 is securely received by a knob 27 which may include a knurled surface for manipulation by the fingers of a user.

An end contacting portion 28 of the threaded shaft acts against lower arm 18 such that when the knob 27 is twisted (e.g., clockwise) the lower arm 18 is urged to engage with and clamp the instrument neck. When assembled the end portion 28 is generally hidden from view as it contacts the inside surface of lower arm 18.

The general configuration of an adjuster mechanism as described above is known in the art. It is also common in the art for a metal spring member to be associated between the side arm and lower arm in order to urge the lower arm away from its clamped/closed position (i.e., biasing against the tightening screw thread), however, such spring arrangements require additional manufacturing steps and, in the case of a leaf spring, require an additional pin to pass through the lower arm to provide a surface against which the leaf spring can act.

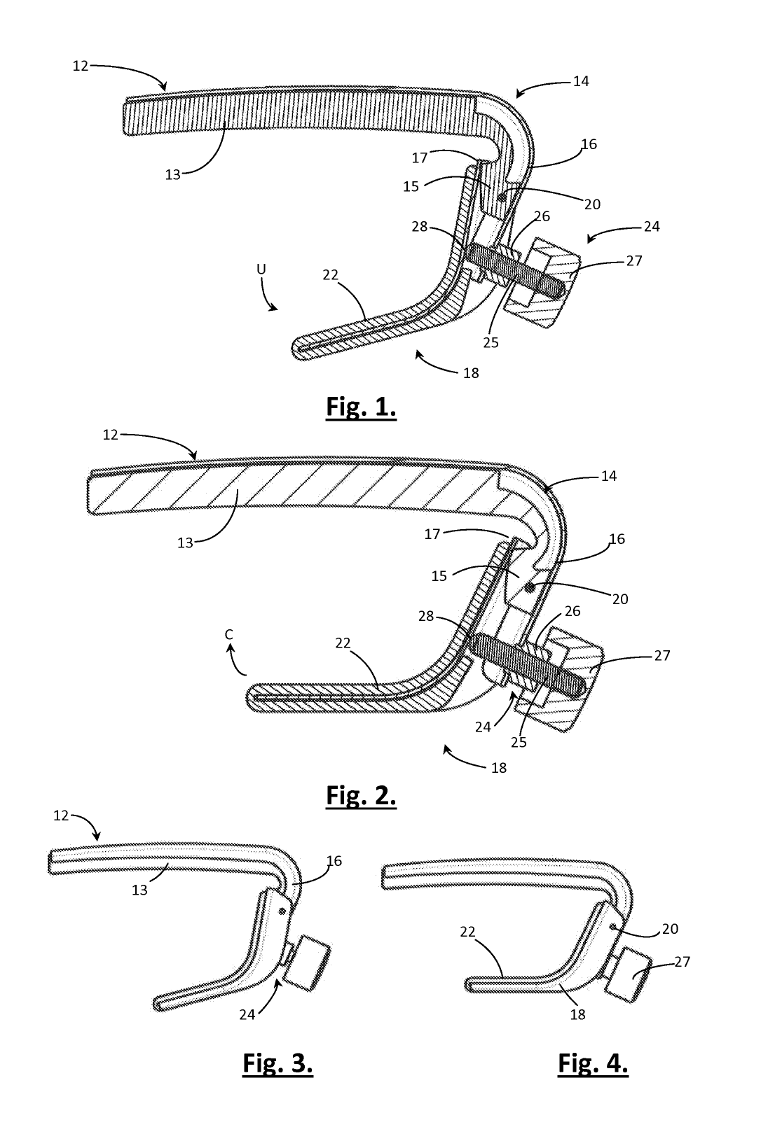

The complexity of the prior art has been addressed by utilizing the resilient nature of the engaging surface rubber 13 of the top arm 12 to be extended around the curve 14 into side arm 16 and at least to be located underneath the pivoting end of lower arm 18. Accordingly, the rubber moulding 13 includes a distal end 15 that is secured by the pivot pin/axis 20 and, furthermore, includes an enlarged portion that extends to contact a hard surface of lower arm 18 which overhangs the pivot. By the resilient nature of the material, lower arm 18 is naturally urged in a direction U (FIG. 1) toward an open position as the screw thread is loosened. The adjuster mechanism 24 works against this bias by tightening the lower arm 18 in a clamping direction C (FIG. 2).

Top/side arms 12, 16 are preferably pressed in a single piece from a suitable metal material that forms a component with a U-shaped cross-section channel. Likewise, lower arm 18 can be pressed in a single piece with a U-shaped cross-section which is marginally wider than the top/side arm component such that the side arm is received into the U-shaped channel of lower arm 18. A pin 20 is then passed through both components to form a permanent pivoting connection as best seen in FIGS. 3 and 4.

The resilient rubber material affixed to top arm 12 and side arm 16 in the vicinity of pivot 20 is arranged to fit within the U-shaped channel of the pressed piece. Resilient padding 22 is affixed to the lower arm 18 both by suitable attachment means to the upper surface (e.g. glue) and fitted within the channel of the lower surface.

In totality the capo of the disclosure provides a simple, low cost construction which is effective for clamping the strings of an instrument to a desired tension, by virtue of the screw adjustment. The capo is easily removable due to the automatic outward bias of the resilient material located to contact against an overhanging pivoting end 17 of the lower arm 18.

It should be noted in the foregoing description, certain terminology is used for the purpose of reference only and is not intended to be limiting. For example, terms such as “upper, lower, above, below, top, bottom, underside, topside,” etc. describe the orientation of portions of the capo within a consistent but arbitrary frame of reference which is made clear by reference to the accompanying drawings.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A capo for use with a stringed instrument having a neck with a finger board and a back and strings that extend longitudinally over the finger board, the capo comprising:
a top arm with a string facing side configured to, in use, extend across the finger board over the strings;
a side arm connected and extending at an angle to the top arm and arranged to extend laterally of the neck;
a lower arm having one end pivotally attached to the side arm at a pivot point and configured to, in use, abut against the back of the neck of the instrument when in a closed position;
an adjuster mechanism that projects from the side arm and having an end portion that bears against the lower arm such that it is able to cause the lower arm to move toward the back of the neck to the closed position; and
a resilient material provided on the string facing side of the top arm that extends from the top arm onto the side arm, toward the location of the pivot point, in order to provide a biasing force on the lower arm away from the back of the neck.

2. The capo of claim 1 wherein the resilient material includes an enlarged or protruding portion that contacts with a surface of the lower arm.

3. The capo of claim 2 wherein the surface of the lower arm being contacted overhangs the pivot point with the side arm.

4. The capo of claim 1 wherein the pivot point passes through a portion of the resilient material.

5. The capo of claim 1 wherein the end portion of the adjuster mechanism is the end of a threaded shaft, which is rotatable by manipulation of a knob, and movable within a threaded boss located on the side arm.

6. The capo of claim 1 wherein the top, side and lower arms are formed components with a u-shape cross section.

7. The capo of claim 6 wherein the lower arm cross section is wider than the side arm to accommodate the side arm therein when the components are joined together at the pivot point.

8. The capo of claim 1 wherein the lower arm includes a soft or resilient material on a surface for contacting with the back of the instrument neck.
